(19) United States
(12) Patent Application Publication
(10) Pub. No.: US 2013/0222867 A1
(43) Pub. Date: Aug. 29, 2013

(54) Image Reader and Sheet Conveyer

(71) Applicant: Ryuta Tomita, Toyoake-shi (JP)

(72) Inventor: Ryuta Tomita, Toyoake-shi (JP)

(73) Assignee: Brother Kogyo Kabushiki Kaisha, Nagoya-shi (JP)

(21) Appl. No.: 13/774,094

(22) Filed: Feb. 22, 2013

(30) Foreign Application Priority Data
Feb. 24, 2012 (JP) 2012-038284

(51) Int. Cl. H04N 1/00

(52) U.S. Cl. CPC H04N 1/0057
USPC 358/498

(57) ABSTRACT

A sheet conveyer including a first chassis and a second chassis, a conveying unit to convey a sheet in a conveying route between the first chassis and the second chassis, an emitter disposed on one of the first chassis and the second chassis and configured to emit ultrasonic waves toward the conveying route, a receiver disposed on the second chassis and configured to receive the ultrasonic waves and to output detecting signals, which are to be used to determine whether the sheet being conveyed in the conveying route includes multiple sheets, and a power source disposed on the second chassis and configured to supply power to the emitter, and the receiver, is provided.

### CROSS REFERENCE TO RELATED APPLICATION

This application claims priority from Japanese Patent Application No. 2012-038284, filed on Feb. 24, 2012, the entire subject matter of which is incorporated herein by reference.

### BACKGROUND

1. Technical Field

An aspect of the disclosure relates to an image reader and a sheet conveyer.

2. Related Art

An image reader including an upper chassis and a lower chassis, which face each other across a conveyer path to convey a sheet, is known. In order to detect multiple feed of sheets conveyed along the conveyer path, for example, the image reader may be equipped with a sensor including an emitter and a receiver. The emitter may be disposed, for example, on the lower chassis, and the receiver may be disposed on the upper chassis. The emitter may emit ultrasonic waves toward the conveyer path, and the receiver may receive the emitted ultrasonic waves. Thus, the sensor may output detected signals, by which multiple feed of sheets conveyed along the conveyer path can be recognized.

The receiver to receive the ultrasonic waves may have such a characteristic that sensitivity thereof may be lowered when temperature in the receiver is low. Therefore, in the image reader, the receiver may be disposed in a position adjacent to a light source of a display unit, which is disposed on the upper chassis. Thus, the receiver may be maintained warmed by heat from the light source.

### SUMMARY

In recent years, however, image readers often employ lower-heat producing light sources, such as fluorescence lamps and LEDs, of which amounts of heat to be produced are relatively low, for the light sources of display units. Therefore, if temperature in the ambient air surrounding the image reader is low, the receiver may not be warmed up sufficiently by the light source with lower heat, and the receiver may not provide sufficient sensitivity. As a result, the image reader may have difficulty to detect the multiple feed of sheets accurately depending on the temperature in the ambient air.

An aspect of the present disclosure is advantageous in that an image reader, which is capable of detecting multiple sheets in a conveyer path accurately regardless of temperature in ambient air, is provided.

According to an aspect of the disclosure, an image reader is provided. The image reader includes a first chassis and a second chassis; a conveying unit configured to convey a sheet in a conveying route between the first chassis and the second chassis; a reading unit configured to read an image of the sheet; an emitter disposed on one of the first chassis and the second chassis and configured to emit ultrasonic waves toward the conveying route; a receiver disposed on the second chassis and configured to receive the ultrasonic waves and to output detecting signals, which are to be used to determine whether the sheet being conveyed in the conveying route includes multiple sheets; and a power source disposed on the second chassis and configured to supply power to the reading unit, the emitter, and the receiver.

According to another aspect of the disclosure, a sheet conveyer is provided. The sheet conveyer includes a first chassis and a second chassis; a conveying unit configured to convey a sheet in a conveying route between the first chassis and the second chassis; an emitter disposed on one of the first chassis and the second chassis and configured to emit ultrasonic waves toward the conveying route; a receiver disposed on the second chassis and configured to receive the ultrasonic waves and to output detecting signals, which are to be used to determine whether the sheet being conveyed in the conveying route includes multiple sheets; and a power source disposed on the second chassis and configured to supply power to the emitter and the receiver.

### BRIEF DESCRIPTION OF THE ACCOMPANYING DRAWINGS

FIG. 1 is a perspective view of an image reading apparatus 1 showing a front face.

FIG. 2 is a perspective view of the image reading apparatus 1 showing the front face with a feeder tray 50 and an ejection tray 6 being open.

FIG. 3 is a perspective view of the image reading apparatus 1 showing a rear face with the feeder tray 50, the ejection tray 6 being open.

FIG. 4 is a side view of the image reading apparatus 1.

FIG. 5 is a cross-sectional side view of the image reading apparatus 1.

FIG. 6 is a partially enlarged cross-sectional view of the image reading apparatus 1 taken along a line A-A shown in FIG. 5.

FIG. 7 is a diagram to illustrate relative positions of a power unit 3, control board 5, and a receiver 102 in the image reading apparatus 1.

FIG. 8 is a perspective view showing a rear side of a bulkhead 93 in the image reading apparatus 1.

### DETAILED DESCRIPTION

Hereinafter, an image reading apparatus 1 as an example embodiment of an image reader according to the disclosure will be described with reference to the accompanying drawings.

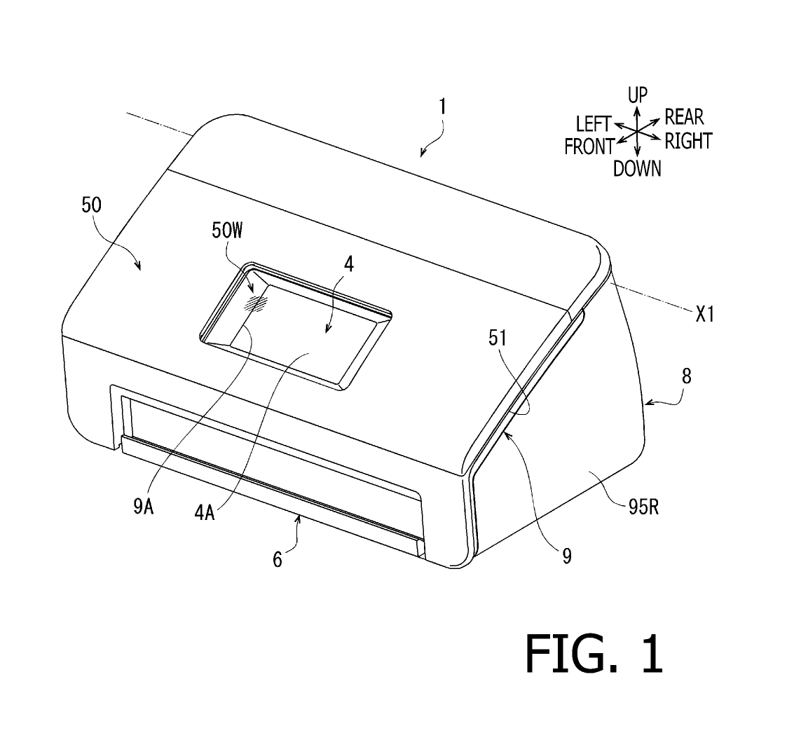

In the example embodiment described below, directions concerning the image reading apparatus 1 will be referred to based on orientations indicated by arrows shown in each drawing. For example, a viewer's lower-left side appearing in FIG. 1, on which an ejection tray 6 is arranged, is referred to as a front face of the image reading apparatus 1. An upper-right side in FIG. 1, opposite from the front face, is referred to as a rear face. A side, which corresponds to the viewer's upper-left side is referred to as a left-side face, and an opposite side from the left, which corresponds to the viewer's lower-right side, is referred to as a right-side face. The right-left direction of the image reading apparatus 1 may also be referred to as a crosswise or lateral direction. The up-down direction in FIG. 1 corresponds to a vertical direction of the image reading apparatus 1.

Configuration of the Image Reading Apparatus 1

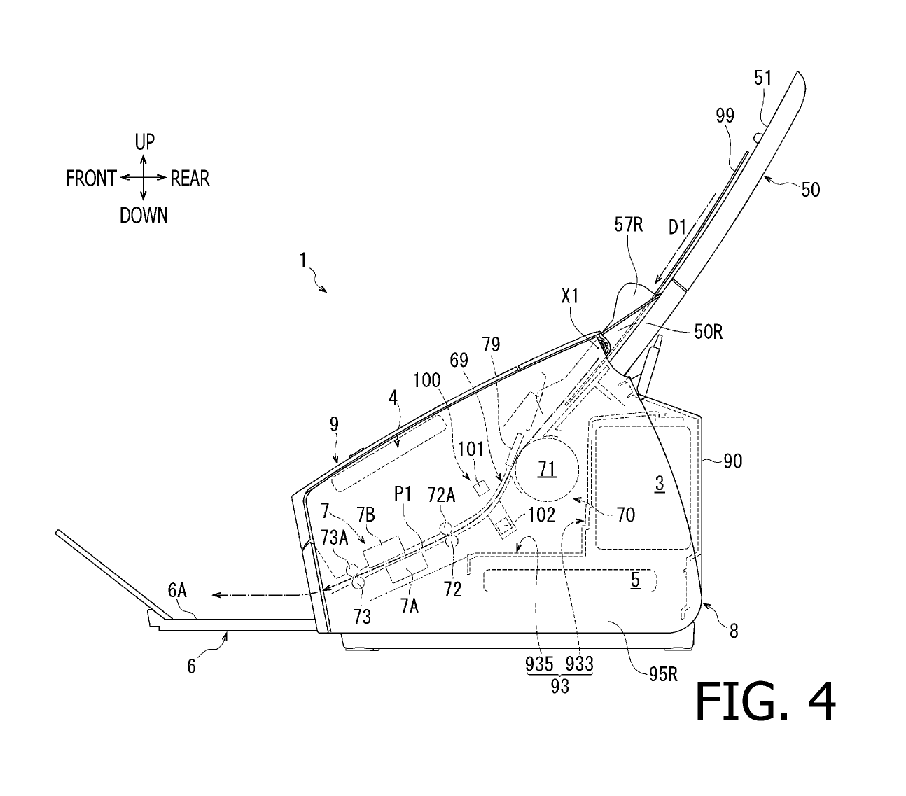

As shown in FIGS. 1-5, the image reading apparatus 1 includes a first chassis 9, a second chassis 8, a feeder tray 50, and an ejection tray 6. Further, as represented in FIG. 4, a conveying route P1, in which a sheet 99 is conveyed from the feeder tray 50 to the ejection tray 6, is provided in the image reading apparatus 1. The first chassis 9 and the second chassis 8 are disposed to face vertically each other across the conveying route P1.

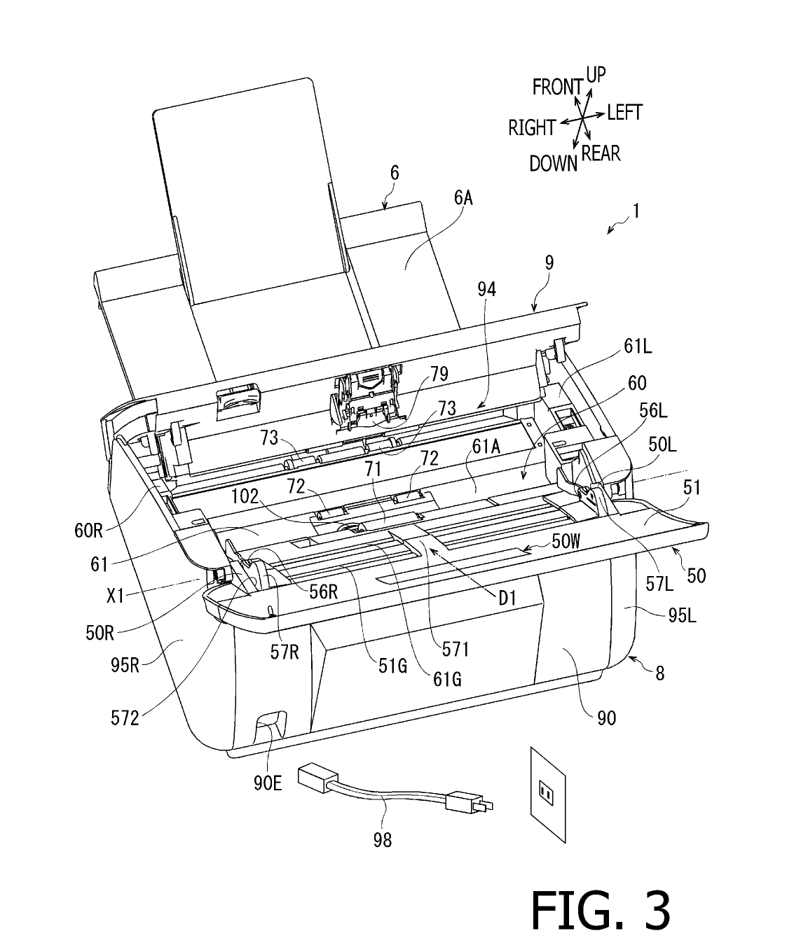

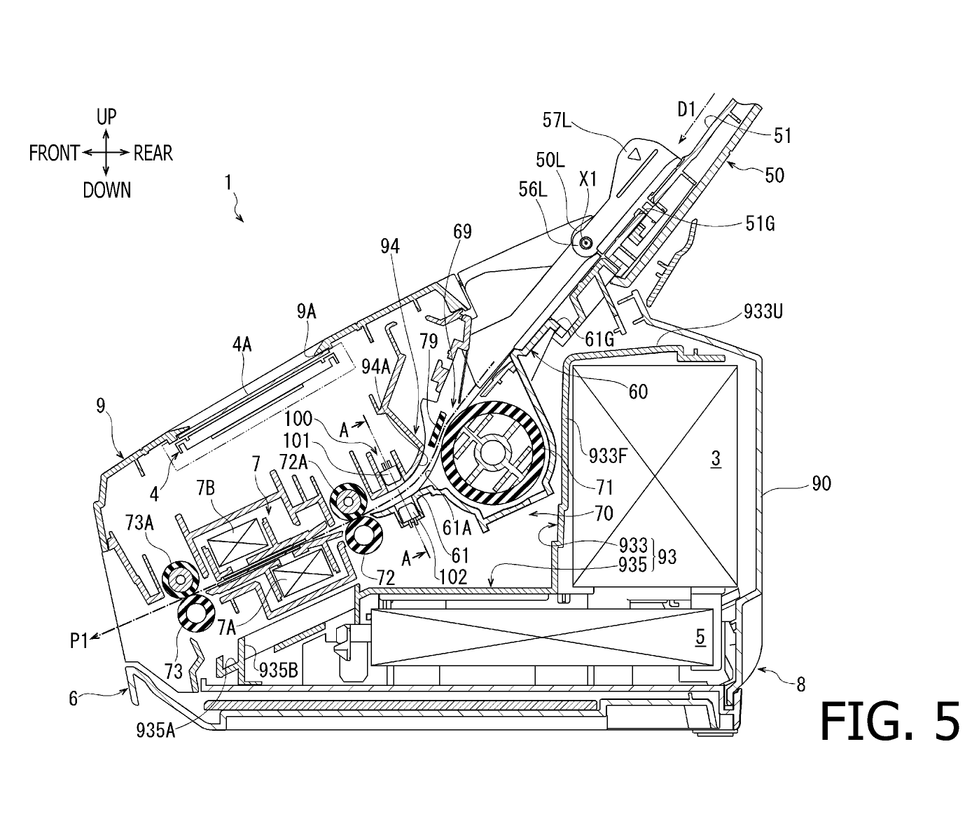

More specifically, the second chassis 8 is a box-shaped container including a lower chute 60, a rear cover 90, and lateral covers 95R, 95L (see FIGS. 3 and 5). The second chassis 8 further includes internal frames covered by the lower chute 60, the rear cover 90, and the lateral covers 95R, 95L. The internal frames include a bulkhead 93 (see FIG. 5) and additional frames (not shown), which are assembled together.

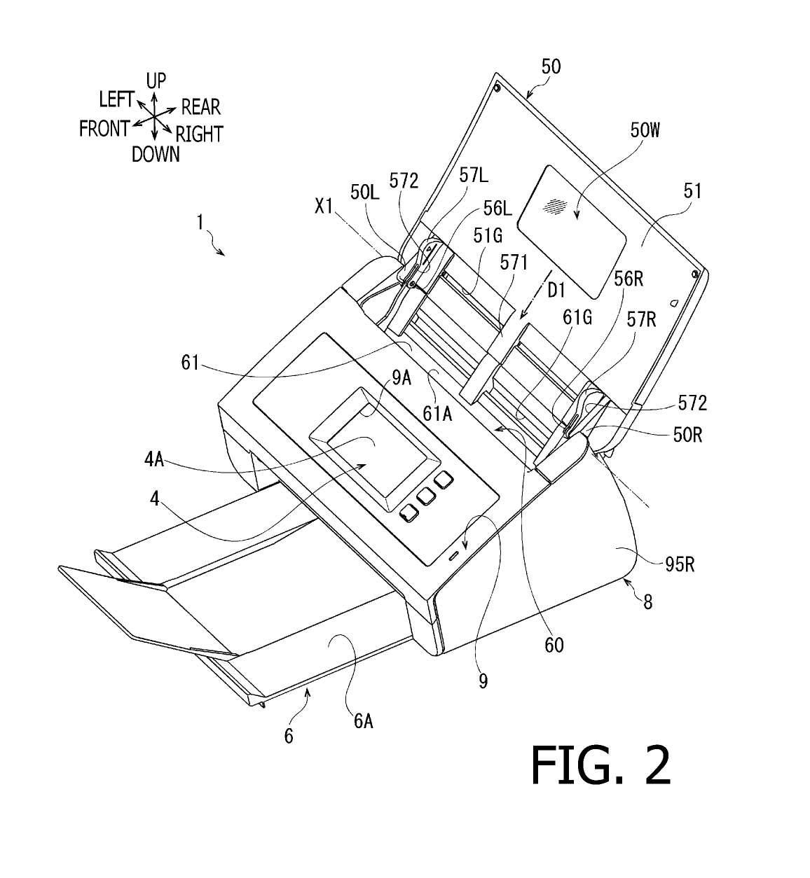

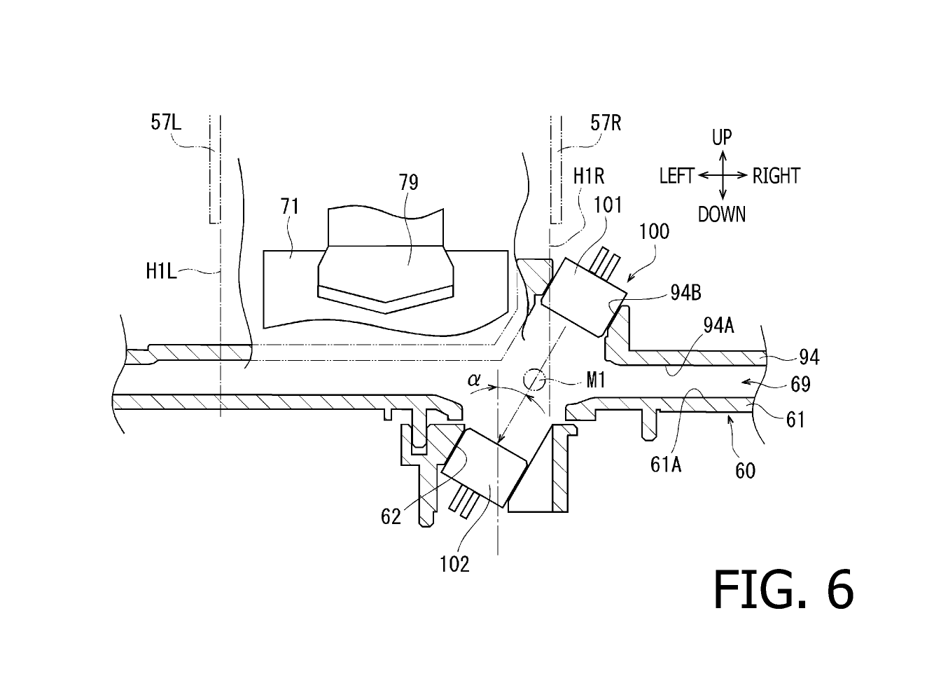

As shown in FIGS. 2 and 5, the first chassis 9 is arranged to incline upward from the front face toward the rear face of the image reading apparatus 1. As shown in FIGS. 5 and 6, the first chassis 9 includes an upper guide 94, which faces the lower chute 60 from above. A lower side of the upper guide 94 provides an upper guide plane 94A being a top plane of a conveyer path 69.

Although not shown, the first chassis 9 is swingaly supported by the second chassis 8 at a front edge thereof. As shown in FIG. 3, the first chassis 9 is swingable to uplift a rear end thereof upward and separated from the lower chute 60. Thus, when, for example, a user needs to deal with sheet jam or other maintenance operations, the user can access a lower guide 61 being a bottom of the lower chute 60, a feed roller 71 in a conveyer unit 70, or conveyer rollers 72 by uplifting the first chassis 9.

As represented in FIG. 2, the feeder tray 50 is formed in a shape of a thin plate, one side of which is configured to serve as a placement surface 51. On right-side and left-side corners of the feeder tray 50, hinges 50R, SOL are integrally formed. The feeder tray 50 is swingably supported by the second chassis 8 to swing about a swing axis X1, which extends in a crosswise direction at an upper rear position in the second chassis 8, via the hinges 50R, SOL.

As shown in FIG. 1, when in a closed posture, the feeder tray 50 is placed over the first chassis 9 with the placement surface 51 facing downward. The position of the feeder tray 50 in the closed posture shown in FIG. 1 will be referred to as “housed position.”

When being rotated about the swing axis X1, as shown in FIGS. 2-5, the feeder tray 50 is moved to a rearward position with respect to the second chassis 8 and into an open posture, in which the placement surface 51 faces upward. The position of the feeder tray 50 in the open posture as shown in FIG. 2 will be referred to as “usable position.”

When the feeder tray 50 is in the usable position, the sheet 99 can be placed on the placement surface 51 and can be conveyed from the placement surface 51 frontward by the feed roller 71 to be fed in the conveyer path 69 along a conveying direction D1 toward the ejection tray 6 (see FIG. 4). In this regard, a direction of width of the sheet 99 (“sheet-width”) conveyed in the conveying route P1 coincides with the crosswise (lateral) direction of the image reading apparatus 1.

As shown in FIG. 3, the lower chute 60 includes a lower guide 61, which is formed in a shape of a flat panel, and lateral walls 60R, 60L, which have the lower guide 61 interposed in a midst position there-between. The lower guide 61 spreads in parallel with the crosswise direction and extends in an angled posture to decline from the rear side toward the ejection tray 6 on the front side. As shown in FIGS. 5 and 6, an upper surface of the lower guide 61 faces the upper guide plane 94A of the first chassis 9 from a lower position across the conveying route P1. An upper plane of the lower guide 61 serves as a bottom plane 61A of the conveyer path 69. When the feeder tray 50 is in the usable position, the bottom plane 61A provides an inclined surface in continuity with the placement surface 51.

As represented in FIG. 2, the image reading apparatus 1 includes a pair of rib-shaped guide pieces 57R, 57L. The guide pieces 57R, 57L extend in parallel with the conveying direction D1 from an upper end of the placement surface 51 to the bottom plane 61A. Each of the guide pieces 57R, 57L is formed to have a joint 56R, 56L in a longitudinally (along the conveying direction D1) midst position. The joints 56R, 56L allow the guide pieces 57R, 57L to be folded or to align straight by rotating about the swing axis X1 when the feeder tray 50 is moved from the housed position to the usable position, and vice versa.

On the placement surface 51 and the bottom plane 61A, guide rails 51G, 61G being narrow grooves extending in the crosswise direction are formed. The guide pieces 57R, 57L are engaged with the guide rails 51G, 61G and slidable in the crosswise direction with reference to the crosswise center on the placement surface 51 and the bottom plane 61A to be close to or apart away from each other. The placement surface 51 and the bottom plane 61A are formed to have a first restricting portion 571 on the widthwise center thereof. The first restricting portion 571 is a protrusion extending along the conveying direction D1. On laterally outer sides of the guide rails 51G, 61G, second restricting portions 572, which are lateral walls of the hinges 50R, SOL, are formed to face each other.

As indicated by double-dotted dashed lines in FIG. 6, the guide pieces 57R, 57L may be placed in mutually closest positions, in which a crosswise distance between the guide pieces 57R, 57L is the smallest, whilst lateral edges of the first restricting portion 571 are contacted by the guide pieces 57R, 57L. In other words, the guide pieces 57R, 57L cannot be moved closer to each other beyond the first restricting portion 571. Therefore, when the guide pieces 57R, 57L are in the closest positions, the sheet 99, even smaller-sized sheets 9 such as a business card and a letter sheet, can be placed on a laterally correct position with reference to the widthwise center on the placement surface 51 and the bottom plane 61A as long as the smaller-sized sheet 99 fits in the smallest distance between the guide pieces 57R, 57L.

Meanwhile, although not shown, the guide pieces 57R, 57L may be placed in mutually farthest positions, in which the crosswise distance between the guide pieces 57R, 57L is the largest with outer side planes of the guide pieces 57R, 57L being in contact with the second restricting portions 572 respectively. Therefore, when the guide pieces 57R, 57L are in the farthest positions, the sheet 99, even a sheet 99 in a maximum allowable size (e.g., A4 size or legal size), can be placed on a laterally correct position with reference to the widthwise center on the placement surface 51 and the bottom plane 61A as long as the large-sized sheet 99 fits in the farthest distance between the guide pieces 57R, 57L.

As shown in FIGS. 1 and 2, the ejection tray 6 can be stored in or drawn out of the second chassis 8. When the ejection tray 6 is stored in the second chassis 8 (see FIG. 1), the ejection tray 6 is exposed only at a front end of the ejection tray 6. When the ejection tray 6 is drawn out of the second chassis 8 (see FIG. 2), the ejection tray 6 can be placed in a posture to have a discharge surface 6A facing upward in a frontward position with respect to the second chassis 8.

The image reading apparatus 1 further includes a power unit 3, a control board 5, a display unit 4, a conveyer unit 70, a multi-sheets sensor 100, and a reader unit 7 (see FIGS. 4 and 5).

The power unit 3 is disposed inside the second chassis 8 on a side closer to the rear face of the second chassis 8. The power unit 3 is an alternate current adaptor, which converts alternate current from an electricity outlet into direct current and supply the electricity to the control board 5, the display unit 4, the conveyer unit 70, the multi-sheets sensor 100, and the reader unit 7. A rear side of the power unit 3 is covered by the rear cover 90. As shown in FIG. 3, on the rear cover 90, a connector hole 90E is formed. In the connector hole 90E, an end of an electricity cable 98 to electrically connect the power unit 3 with the electricity outlet is inserted.

As shown in FIGS. 4 and 5, the control board 5 is arranged in a lower position with respect to the power unit 3 in the second chassis 8. The control board 5 is electrically connected with the conveyer unit 70, the reader unit 7, the multi-sheets sensor 100, and the display unit 4 by cables (not shown) to control behaviors of these units.

As represented in FIG. 5, the display unit 4 is installed in an upper position inside the first chassis 9 to have a display surface 4A thereof exposed through a rectangular-shaped aperture 9A, which is formed through the upper plane of the first chassis 9. The display unit 4 includes a known liquid crystal panel and a light source, such as a fluorescent lamp and an LED, which illuminates the liquid crystal panel from a back side (i.e., a lower side in FIG. 5). The display unit 4 displays information concerning an operation in the image reading apparatus 1, including processing status of the reader unit 7, to be seen by the user. As shown in FIGS. 1 and 2, in a position in the feeder tray 50 corresponding to the display surface 4A, a transparent or semi-transparent window 50W is arranged. Thus, even when the feeder tray 50 is in the housed position as shown in FIG. 1, the information displayed on the display surface 4A can be recognized by the user through the window 50W.

As shown in FIGS. 4 and 5, the conveyer unit 70 includes the feed roller 71, a separator pad 79, the multiple-sheets sensor 100, a conveyer roller 72, a driven roller 72A, an ejection roller 73, and a driven roller 73A. The multiple-sheets sensor 100 includes an emitter 101 and a receiver 102. The reader unit 7 includes image reading sensors 7A, 7B. These components are arranged in the conveyer path 69 along the conveyer direction D1 from upstream to downstream in an order: the feed roller 71 and the separator pad 79; the emitter 101 and the receiver 102; the conveyer roller 72 and the driven roller 72A; the image reading sensors 7A, 7B; and the ejection roller 73 and the driven roller 73A.

The feed roller 71 is attached to the lower chute 60 and is arranged on the lower guide 61 in the conveyer path 69. The feed roller 71 is driven to rotate by a driving source (not shown) and feeds the sheet 99 to the conveyer path 69 along the conveying direction D1 by being rotated whilst the sheet 99 placed on the placement surface 51 is in contact with the feed roller 71.

The separator pad 79 is attached to the first chassis 9 and is arranged on the upper guide 94 in the conveyer path 69. The separator pad 79 is a thin piece of frictional material, such as rubber or elastomer. The separator pad 79 is arranged in a position to face the feed roller 71 and urged against the feed roller 71 by a resilient member (not shown). Thereby, the separator pad 79 nips the sheet 99 in cooperation with the feed roller 71 and separates the sheet 99 from the other sheets, which may otherwise be fed in the conveyer path 69 along with the sheet 99.

The emitter 101 in the multiple-sheets sensor 100 emits ultrasonic waves toward the conveying route P1 from above, and the receiver 102 receives the transmitted ultrasonic waves at a lower position (see FIGS. 5 and 6).

More specifically, as shown in FIG. 6, the emitter 101 is housed in an emitter housing hole 94B, which is formed to recess from the upper guide plane 94A of the upper guide 94 in upper-rightward inclination. The emitter 101 is disposed in a rightward position with respect to the feed roller 71 and the separator pad 79. In the cross sectional view shown in FIG. 6, taken along the line A-A (see FIG. 5), the feed roller 71 and the separator pad 79 are located on a farther side with respect to the upper guide 94 of the upper cover 93. Therefore, the feed roller 71 and the separator pad 79 interfered with by the upper guide 94 should not be seen in FIG. 6. However, in FIG. 6, a part of the upper guide 94 is indicated in an imaginary line to show the positions of the feed roller 71 and the separator pad 79.

Meanwhile, the receiver 102 is housed in a sensor housing hole 62, which is formed to recess from the bottom plane 61A of the lower guide 61 in lower-leftward inclined orientation. The receiver 102 is located in a rightward position with respect to the separator pad 79. A direction to emit the ultrasonic waves from the emitter 101 toward the receiver 102 is inclined rightward at an angle α with respect to the vertical direction. In the example embodiment, the angle α is 30 degrees.

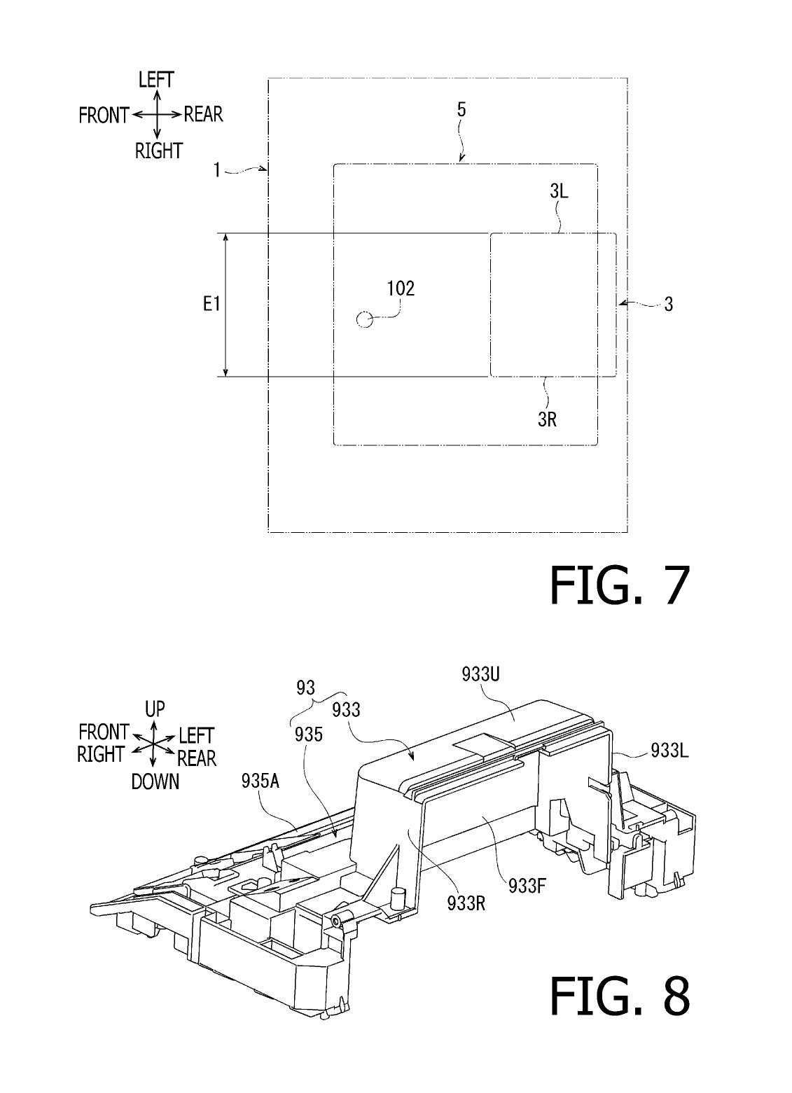

As shown in FIG. 7, when the image reading apparatus 1 is viewed from above, the receiver 102 is disposed within a crosswise range E1 between a leftward end 3L and a rightward end 3R of the power unit 3. In this regard, the receiver 102 is disposed in an upper position with respect to the control board 5 and within a range, which does not vertically coincide with the power unit 3.

The guide pieces 57R, 57L in the closest position are indicated in double-dotted dashed lines in FIG. 6. In FIG. 6, further, a measurement point M1, in which the ultrasonic waves emitted from the emitter 101 toward the receiver 102 intersect the conveyer path 69, is indicated. The ultrasonic waves emitted from the emitter 101 transmit the sheet 99 being conveyed in the conveyer path 69 at the measurement point M1. The measurement point M1 is located in a crosswise position between the guide pieces 57R, 57L in the closest position (i.e., between auxiliary lines H1R, H1L, which are vertically extended from the guide pieces 57R, 57L).

As shown in FIG. 5, the conveyer roller 72 is attached to the lower chute 60 and is arranged on the lower guide 61 of the conveyer path 69. The conveyer roller 72 is driven by a driving source (not shown) and rotates synchronously with the feed roller 71. The driven roller 72A is attached to the first chassis 9 and is arranged on the upper guide 94 in the conveyer path 69. The driven roller 72A is arranged to vertically face the conveyer roller 72 from above. The driven roller 72A is urged against the conveyer roller 72 by a resilient member (not shown). Thereby, the conveyer roller 72 nips the sheet 99 in cooperation with the driven roller 72A and rotates to convey the sheet 99 toward the downstream along the conveying direction D1.

The image reading sensor 7A is attached to the lower chute 60 and is arranged on the lower guide 61 in the conveyer path 69. The image reading sensor 7B is attached to the first chassis 9 and is arranged on the upper guide 94 in the conveyer path 69. Thus, the image reading sensors 7A, 7B face each other vertically across the conveying route P1. The image reading sensors 7A, 7B may be, for example, a contact image sensor (CIS) or a charge coupled device (CCD). The image reading sensors 7A, 7B are disposed on an opposite side from the power unit 3 across the receiver 102.

The ejection roller 73 is attached to the lower chute 60 and is arranged on the lower guide 61 in the conveyer path 69. The ejection roller 73 is driven by a driving source (not shown) and rotates synchronously with the feed roller 71 and the conveyer roller 72. The driven roller 73A is attached to the first chassis 9 and is arranged on the upper guide 94 of the conveyer path 69. The driven roller 73A is arranged to vertically face the ejection roller 73 from above. The driven roller 73A is urged against the ejection roller 73 by a resilient member (not shown). Thereby, the ejection roller 73 nips the sheet 99 in cooperation with the driven roller 73A and rotates to convey the sheet 99 to the ejection tray 6, which is in a downstream position with respect to the ejection roller 73 along the conveying direction D1.

As shown in FIG. 5, inside the second chassis 8, a bulkhead 93 is provided. As shown in FIG. 8, the bulkhead 93 is an integrally formed resin piece and includes a power unit cover 933 and a board cover 935.

The power unit cover 933 includes an upper face 933U, which covers the power unit 3 from above and from lateral sides, a front face 933F, and lateral (right and left) faces 933R, 933L.

The board cover 935 is continuously formed from the upper face 933Y via lower edges of the front face 933F and the lateral faces 933R, 933L to extend frontward and laterally in a plane and covers the control board 5 from above.

As shown in FIG. 5, inside the second chassis 8, the power unit 3 and the control board 5 are separated from the receiver 102 and the image reading sensor 7A by the power unit cover 933 and the board cover 935. The board cover 935 is formed to have an inclined section 935A, which inclines to be lower toward the front side, at a front end thereof. In the inclined section 935A, a cable hole 935B, which penetrates the inclined section 935A vertically, is formed. Through the cable hole 935B and other opening (not shown) formed on the inclined section 935A, cables and wires to electrically connect the control board 5 with the image reading sensors 7A, 7B, the emitter 101, the receiver 102, and the display unit 4 may be arranged to penetrate the front inclined section 935B.

Image Reading Operation

An image reading operation to read images appearing on the sheet 99 will be described below. When the operation starts, firstly, the conveyer unit 70 is activated under control of the control board 5. In particular, the feed roller 71 rotates whilst the sheet 99 is nipped in between the feed roller 71 and the separator pad 79. Thus, the sheet 99 on the placement surface 51 is picked up and fed in the conveyer path 69 along the conveying direction D1. If multiple sheets are picked up in layer, solely one sheet 99 is separated from the others by the effect of friction force caused between the separator pad 79 and forwarded in the conveyer path 69.

Secondly, whilst the separated sheet 99 is guided by the upper guide plane 94A and the bottom plane 61A and conveyed along the conveying route P1 in the conveying direction D1, the multiple-sheets sensor 100 detects whether the sheet 99 has been separated from the other sheets by the separator pad 79.

More specifically, the multiple-sheets sensor 100 emits ultrasonic waves from the emitter 101 and receives the emitted ultrasonic waves in the receiver 102 under control of the control board 5. If the sheet 99 is in the conveyer path 69 when the ultrasonic waves are emitted from the emitter 101, the emitted ultrasonic waves transmit the sheet 99, and the waves to be received in the receiver 102 attenuate to a specific level. In this regard, attenuation rate for the ultrasonic waves depends on a quantity of sheets 9 being conveyed in the conveyer path 69. In other words, when two or more sheets 9 are conveyed in a layer in the conveyer path 69, the ultrasonic waves attenuate largely compared to attenuation of the ultrasonic waves transmitting a single sheet 9. The multiple-sheets sensor 100 thus senses whether the sheet 9 being conveyed includes two or more sheets to detect the presence of multiple sheets based on the attenuation rate of the ultrasonic waves being received. The receiver 102 outputs the signals detected by the difference in the attenuation rates of the ultrasonic waves to the control board 5. The control board 5 receiving the detected signals determines whether multiple sheets 99 are conveyed along the conveying route P1.

If the multiple-sheets sensor 100 detects presence of multiple sheets 99, the control board 5 deals with the presence of multiple sheets by, for example, aborting the image reading operation and notifying the user of the presence of multiple sheets.

Thirdly, the conveyer roller 72 forwards the separated sheet 99 in the conveyer path 69, and the image reading sensors 70A, 70B read images appearing on the upper and lower sides of the sheet 99. The sheet 99 is thereafter conveyed to be ejected on the discharge surface 6A of the ejection tray 6 by the ejection roller 73.

Effects of the Present Disclosure

According to the image reading apparatus 1 described above, the receiver 102 and the power unit 3 are disposed on the same second chassis 8. In this regard, an amount of heat to be produced in the power unit 3 is greater than the amount of heat to be produced by the lower-heat producing light source, such as a fluorescent lamp and an LED, for the display unit 4. Therefore, the receiver 102 may be warmed up by the heat from the power unit 3 even if temperature in the ambient air is low. Accordingly, in the image reading apparatus 1, higher sensitivity of the receiver 102, compared to an image reader, in which a receiver is heated by a light source for a display unit, may be maintained.

In other words, the image reading apparatus 1 can detect multiple sheets being conveyed accurately regardless of the temperature in the ambient air.

Further, in the image reading apparatus 1, the receiver 102 is disposed in the range E1 (see FIG. 7) along the widthwise direction, i.e., the crosswise (right-left) direction, of the sheet 99 being conveyed along the conveying route P1, between the rightward end 3R and the leftward end 3L of the power unit 3. With this arrangement, the receiver 102 can be disposed in a relatively close position to the power unit 3 compared to an arrangement, in which the receiver 102 is disposed outside the range E1 along the crosswise direction. Therefore, the receiver 102 can be efficiently heated by the heat from the power unit 3, and the multiple-sheets sensor 100 can provide the higher sensitivity to detect the multiple sheets in the conveyer path 69.

In the image reading apparatus 1, as shown in FIG. 5, the image reading sensors 7A, 7B are disposed in the positions opposite from the power unit 3 across the receiver 102. In other words, with this arrangement, the image reading sensors 7A, 7B are disposed in the positions farther from the power unit 3 compared to the receiver 102. While reading quality of the image reading sensors 7A, 7B tends to be lowered by being heated excessively, in the above-described arrangement, the image reading sensors 7A, 7B can be prevented from being heated excessively by the heat from the power unit 3. Thus, the reading quality of the image reading sensors 7A, 7B can be prevented from being lowered.

In the image reading apparatus 1, as shown in FIG. 5, the first chassis 9 is disposed in the upper position with respect to the conveying route P1, and the second chassis 8, on which the power unit 3 is disposed, is arranged in the lower position with respect to the conveying route P1. In other words, with this arrangement, the power unit 3 is located in the lower position with respect to the conveying route P1. Accordingly, a center of gravity of the image reading apparatus 1 is located in a lower position, and the image reading apparatus 1 is securely stabilized.

In the image reading apparatus 1, as shown in FIG. 6, the emitter 101 disposed on the first chassis 9 and the receiver 102 disposed on the second chassis 8 constitute the transmissive-typed sensor, which may more accurately detect presence of multiple sheets compared to a reflective-typed sensor with an emitter and a receiver disposed on the same second chassis 8. Thus, the accuracy of the multiple-sheets sensor 100 may be relatively improved.

In the image reading apparatus 1, as shown in FIG. 5, the display unit 4 is attached to the first chassis 9. Therefore, the display unit 4 is disposed in the distanced position from the power unit 3, which is disposed on the second chassis 8. Accordingly, a display panel (e.g., a liquid crystal panel) in the display unit 4 can be prevented from being heated by the heat produced in the power unit 3. Therefore, an operating life of the display unit 4 can be prevented from being shortened.

In the image reading apparatus 1, the control board 5 is disposed on the second chassis 8 in the lower position with respect to the conveying route P1 along with the power unit 3. Therefore, the center of gravity can be set in the lower position, and the image reading apparatus 1 is even more securely stabilized. Further, with the receiver 102 and the control board 5 disposed on the second chassis 8, the cables and wires to connect the receiver 102 with the control board 5 can be shorter, compared to an arrangement, in which the receiver 102 and the control board 5 are disposed on different chassis. Further, as shown in FIG. 7, the receiver 102 is disposed in the upper position with respect to the control board 5 in the range, which does not vertically coincide with the power unit 3, the wires and the cables to connect the receiver 102 with the control board 5 can be even shorter.

In the image reading apparatus 1, as shown in FIG. 5, the receiver 102 is separated from the power unit 3 by the power unit cover 933 and the board cover 935. Therefore, the power unit cover 933 and the board cover 935 are warmed by the heat from the power unit 3. Accordingly, the receiver 102 can be indirectly warmed by the radiated heat from the power unit cover 933 and the board cover 935. Thus, the receiver 102 can be warmed moderately, compared to a receiver, which is heated directly by the heat from the power unit 3, and the receiver 102 can be prevented from being heated excessively. Accordingly, the image reading apparatus 1 can detect the multiple-feed of the sheets 99 accurately.

Although an example of carrying out the disclosure have been described, those skilled in the art will appreciate that there are numerous variations and permutations of the image reader that fall within the spirit and scope of the disclosure as set forth in the appended claims. It is to be understood that the subject matter defined in the appended claims is not necessarily limited to the specific features or act described above. Rather, the specific features and acts described above are disclosed as example forms of implementing the claims.

For example, the first chassis 9 and the second chassis 8 may not necessarily be arranged in the upper position and the lower position with respect to the conveying route P1, but the vertical positions of the first chassis 9 and the second chassis 8 may be inverted.

For another example, the emitter 101 may not necessarily be disposed on the first chassis 9 but may be disposed on the second chassis 8.

For another example, the reader unit 7 may be replaced with an image forming unit, which forms images on a sheet 99 being conveyed.

For another example, the receiver 102 may not necessarily be disposed in the crosswise range E1 between the rightward end 3R and the leftward end 3L of the power unit 3, but may be disposed outside the crosswise range E1.

For another example, the reader unit 7 may not necessarily be disposed on the opposite side from the power unit 3 across the receiver 102, but may be disposed on the same side as the power unit 3 with respect to the receiver 102.

The image reader described above may be applied to, for example, a sheet conveyer, an image reading apparatus, an image forming apparatus or a multifunction device.

What is claimed is:

1. An image reader, comprising:
a first chassis and a second chassis;
a conveying unit configured to convey a sheet in a conveying route between the first chassis and the second chassis;
a reading unit configured to read an image of the sheet;
an emitter disposed on one of the first chassis and the second chassis and configured to emit ultrasonic waves toward the conveying route;
a receiver disposed on the second chassis and configured to receive the ultrasonic waves and to output detecting signals, which are to be used to determine whether the sheet being conveyed in the conveying route includes multiple sheets; and
a power source disposed on the second chassis and configured to supply power to the reading unit, the emitter, and the receiver.

2. The image reader according to claim 1,
wherein the receiver is disposed in a range between one end of the power source and the other end of the power source along a widthwise direction of the sheet being conveyed in the conveying route.

3. The image reader according to claim 2,
wherein the reading unit is disposed in an opposite side from the power source across the receiver.

4. The image reader according to claim 1,
wherein the first chassis is disposed in an upper position with respect to the conveying route;
wherein the second chassis is disposed in a lower position with respect to the conveying route.

5. The image reader according to claim 4,
wherein the emitter is disposed on the first chassis.

6. The image reader according to claim 4, further comprising:
a display unit disposed on the first chassis.

7. The image reader according to claim 4, further comprising:
a control board disposed on the second chassis and configured to be supplied with the power from the power source.

8. The image reader according to claim 7,
wherein the control board is disposed in a lower position with respect to the receiver and the power source; and
wherein the receiver is disposed in an upper position with respect to the control board and in a range, which does not vertically coincide with the power source.

9. The image reader according to claim 1,
wherein the second chassis comprises a bulkhead, which is positioned between the receiver and the power source.

10. A sheet conveyer, comprising:
a first chassis and a second chassis;
a conveying unit configured to convey a sheet in a conveying route between the first chassis and the second chassis;
an emitter disposed on one of the first chassis and the second chassis and configured to emit ultrasonic waves toward the conveying route;
a receiver disposed on the second chassis and configured to receive the ultrasonic waves and to output detecting signals, which are to be used to determine whether the sheet being conveyed in the conveying route includes multiple sheets; and
a power source disposed on the second chassis and configured to supply power to the emitter and the receiver.

11. The sheet conveyer according to claim 10,
wherein the receiver is disposed in a range between one end of the power source and the other end of the power source along a widthwise direction of the sheet being conveyed in the conveying route.

12. The sheet conveyer according to claim 11,
wherein an image reader unit is disposed in an opposite side from the power source across the receiver.

13. The sheet conveyer according to claim 12,
wherein the power source supplies the power to the image reading unit.

14. The sheet conveyer according to claim 13,
wherein the first chassis is disposed in an upper position with respect to the conveying route;
wherein the second chassis is disposed in a lower position with respect to the conveying route.

15. The sheet conveyer according to claim 14,
wherein the emitter is disposed on the first chassis.

16. The sheet conveyer according to claim 14, further comprising:
a display unit disposed on the first chassis.

17. The sheet conveyer according to claim 14, further comprising:
a control board disposed on the second chassis and configured to be supplied with the power from the power source.

18. The sheet conveyer according to claim 17,
wherein the control board is disposed in a lower position with respect to the receiver and the power source; and
wherein the receiver is disposed in an upper position with respect to the control board and in a range, which does not vertically coincide with the power source.

19. The sheet conveyer according to claim 10,
wherein the second chassis comprises a bulkhead, which is positioned between the receiver and the power source.
